(19) United States
(12) Patent Application Publication
(10) Pub. No.: US 2026/0147215 A1
(43) Pub. Date: May 28, 2026

(54) HEAD-MOUNTABLE DEVICE WITH EYE TRACKING

(71) Applicant: Apple Inc., Cupertino, CA (US)

(72) Inventors: Adam S. MEYER, Cupertino, CA (US); Peter C. TSOI, Redwood City, CA (US)

(21) Appl. No.: 18/962,735

(22) Filed: Nov. 27, 2024

(51) Int. Cl. G02B 27/01; G02B 27/00

(52) U.S. Cl. CPC G02B 27/0176; G02B 27/0093; G02B 2027/0138; G02B 2027/014

(57) ABSTRACT

A head-mountable device can include components that provide eye tracking and image capture of an external environment from a location at one or more arms of the head-mountable device. The frame can provide one or more lenses that facilitate optical detections by cameras at the one or more arms. Accordingly, a frame of the present disclosure need not include components to manage eye tracking and image capture of the external environment. From a set of one or more images, the head-mountable device can determine whether to perform one or more actions based on detected environmental conditions and/or detected eye conditions.

### TECHNICAL FIELD

The present description relates generally to head-mountable devices, and, more particularly, to head-mountable devices with eye tracking.

### BACKGROUND

A head-mountable device can be worn by a user and receive inputs from the user and/or perform detections with respect to the user. The optical components of the head-mountable device can optionally allow a user to observe an environment outside of the head-mountable device. Outputs provided by the head-mountable device can include audio output, visual output, and/or haptic feedback. A user may further interact with the head-mountable device by providing inputs for processing by one or more components of the head-mountable device. For example, the user can provide tactile inputs, voice commands, and other inputs while the device is mounted to the user’s head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device in an assembled configuration, according to some embodiments of the present disclosure.

FIG. 2 illustrates a top view of the head-mountable device of FIG. 1 in an unassembled configuration, according to some embodiments of the present disclosure.

FIG. 3 illustrates a top view of a head-mountable device with a camera, according to some embodiments of the present disclosure.

FIG. 4 illustrates a top view of a head-mountable device with a camera, according to some embodiments of the present disclosure.

FIG. 5 illustrates a top view of a head-mountable device with multiple cameras, according to some embodiments of the present disclosure.

FIG. 6 illustrates a top view of a head-mountable device with a projector and multiple cameras, according to some embodiments of the present disclosure.

FIG. 7 illustrates a top view of a head-mountable device with a projector and multiple cameras, according to some embodiments of the present disclosure.

FIG. 8 illustrates a flow chart for a process having operations for tracking one or more eyes of a user wearing a head-mountable device, according to some embodiments of the present disclosure.

FIG. 9 illustrates a block diagram of at least a portion (e.g., an arm) of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

In some uses, it can be desirable to track the eyes of a user wearing the head-mountable device to facilitate biometric tracking, gaze detection, and/or input detection. For example, a head-mountable device may facilitate optically monitor one or more eyes of the user and perform detections that form a basis for additional operations of the head-mountable device.

Head-mountable devices can also perform a range of functions that is determined by the components (e.g., sensors, circuitry, and other hardware) included with the wearable device as manufactured. However, space, cost, and other considerations may limit the ability to provide every component that might provide a desired function. For example, different users may have different preferences regarding the components and functions that are provided by a given head-mountable device. Some users may prefer a head-mountable device that provides a small form factor at one or more portions of the head-mountable device. For example, it may be desirable to provide a frame with a small form factor. To help achieve such a goal, the head-mountable device can be provided with fewer electronic components at the frame by providing appropriate components at other locations, such as the arms of the head-mountable device. Furthermore, a given user may desire different functions at different times. For example, a given user may desire a frame with electronic components at home and frame that provides a smaller form factor (e.g., without electronic components) when away from home. By further example, a user may desire components having different aesthetic features at different times.

Given the diversity of desired components and functions, it would be beneficial to allow a user to modify components and functions of a head-mountable device to customize the user experience according to the user’s desires while also providing particular functions (e.g., eye tracking) across a variety of possible assemblies. Head-mountable devices of the present disclosure perform eye tracking with components that are located in one or more arms of head-mountable devise to facilitate customization, adaptability, and modification by a user according to the user’s desires.

Systems of the present disclosure can provide a head-mountable device with components that provide eye tracking and image capture of an external environment from a location at one or more arms of the head-mountable device. The frame can provide one or more lenses that facilitate optical detections by cameras at the one or more arms. Accordingly, a frame of the present disclosure need not include components to manage eye tracking and image capture of the external environment. From a set of one or more images, the head-mountable device can determine whether to perform one or more actions based on detected environmental conditions and/or detected eye conditions.

These and other embodiments are discussed below with reference to FIGS. 1-9. However, those skilled in the art will readily appreciate that the detailed description given herein with respect to these Figures is for explanatory purposes only and should not be construed as limiting.

According to some embodiments, for example as shown in FIG. 1, a head-mountable device 10 includes a frame 100 that is worn on a head with one or more arms 200. The frame 100 can be positioned in front of the eyes of a user to provide information within a field of view of the user. The frame 100 can include a frame body 108 that provides nose pads or another feature to rest on a user’s nose. The frame body 108 further includes one or more lenses 132 and a bridge above the nose pads and connecting multiple lenses 132. The lenses 132 can each have surfaces on both of an outer side 102 of the frame 100 and an inner side 104 of the frame 100. As used herein, an outer side 102 of a portion of a head-mountable device 10 (e.g., the frame 100) is a side that faces away from the user and/or towards an external environment. As used herein, an inner side 104 of a portion of a head-mountable device 10 (e.g., the frame 100) is a side that faces toward the user and/or away from the external environment.

In some embodiments, lenses 132 can transmit light from a physical environment for viewing by the user. Such a lens 132 can include optical properties, such lenses for vision correction based on incoming light from the physical environment. In some embodiments, the lenses 132 can provide optical effects. For example, the lenses 132 can provide vision correction to incoming light as appropriate for a given user. Such correction can be spherical, aspheric, atoric, cylindrical, single vision, multifocal, progressive, and/or adjustable. It will be understood that the lenses 132 can include other optical components as required to produce a desired optical effect. For example, the lenses 132 can include and/or be accompanied by one or more diffusers, filters, polarizers, prisms, beam splitters, diffraction gratings, mirrors, and/or windows. Such components can be positioned at any location adjacent to, within, or outside of the frame 100 when assembled with the arms 200.

In some embodiments, as shown in FIG. 1, a frame 100 can be supported on a user’s head with one or more arms 200. The arms 200 can each wrap or extend along opposing sides of a user’s head, as with a temple component. The arm 200 can each include earpieces for wrapping around or otherwise engaging a user’s ears. It will be appreciated that other configurations can be applied for securing the head-mountable device 10 to a user’s head. For example, one or more bands, straps, belts, caps, hats, or other components can be used in addition to or in place of the illustrated components of the head-mountable device 10. By further example, a single arm or other component can extend about a user’s head to both sides of the frame 100.

In some embodiments, as shown in FIG. 1, one or more of the arms 200 can include and/or support one or more cameras 220. The cameras 220 can be positioned on an inner side 104 of the frame 100 while facing a respective lens 132. The cameras 220 can capture images of views transmitted from the external environment and through the respective lens 132. The cameras 220 can capture images of views from the user and reflected by the respective lens 132. The camera 220 can include an optical sensor, such as a photodiode or a photodiode array. Additionally or alternatively, the camera 220 can include one or more of various types of optical sensors that are arranged in various configurations for detecting user inputs described herein.

In some embodiments, one or more cameras can be operated to detect one or more conditions of a user wearing head-mountable device 10, such as a condition of the user’s eyes. Such conditions can include eye gaze direction, pupil location (e.g., eye orientation), pupil size, focal distance, eyelid status (e.g., open, closed, partially open or closed, etc.), blinking, moisture conditions, and the like. Such eye tracking may be used to determine the direction of a user’s attention, which may correspond to one or more features within a field of view of the user. For example, one or more cameras can optically capture a reflected view of an eye (not shown) and determine a direction of a gaze of the user. The detections made by one or more cameras can determine user actions that are interpreted as user inputs. Such user inputs can be used alone or in combination with other user inputs to perform certain actions. By further example, one or more cameras can perform facial feature detection, facial movement detection, facial recognition, user mood detection, user emotion detection, voice detection, and the like.

In some embodiments, one or more cameras can be operated to detect dry eye and/or a moisture condition of the eye. Such a condition can be detected optically at one or more regions of an eye. For example, one or more cameras can detect reflectivity of light projected onto the region with a light emitter and/or another light source. Such reflectivity can be correlated with a moisture condition (e.g., presence or absence of moisture) at the surface of the eye. By further example, one or more cameras can detect a temperature of the eye at one or more regions. Such temperatures can be correlated with a moisture condition (e.g., presence or absence of moisture) at the surface of the eye. Such detected conditions of the eye, such as openness and/or closure, can indicate whether a user is alert and/or aware of a feature and/or event of the environment.

In some embodiments, one or more cameras can be operated to detect blink events, in which the eyelids partially or completely cover the surface of the eye to refresh moisture. Moisture conditions of one or more regions of the eye can be inferred by an amount of time elapsed since the last blink.

In some embodiments, as shown in FIG. 1, one or more of the arms 200 includes one or more other electronic components. For example, one or more of the arms 200 can include one or more processors 292, one or more sensors 294, one or more input/output components 286, one or more communication interfaces 274, and/or one or more batteries 272.

In some embodiments, each of the arms 200 can move (e.g., pivot) about a hinge 244 and with respect to the frame 100. As such, the arms 200 can transition between an extended configuration (as shown in FIG. 1) and a stowed configuration, in which the arms 200 are positioned alongside the frame 100 to reduce the total space occupied by the head-mountable device 10. In the collapsed configuration, the head-mountable device 10 can be stowed while not in use. The hinges 244 can include a mechanical hinge, a magnetic coupling that allows relative rotational movement, and the like.

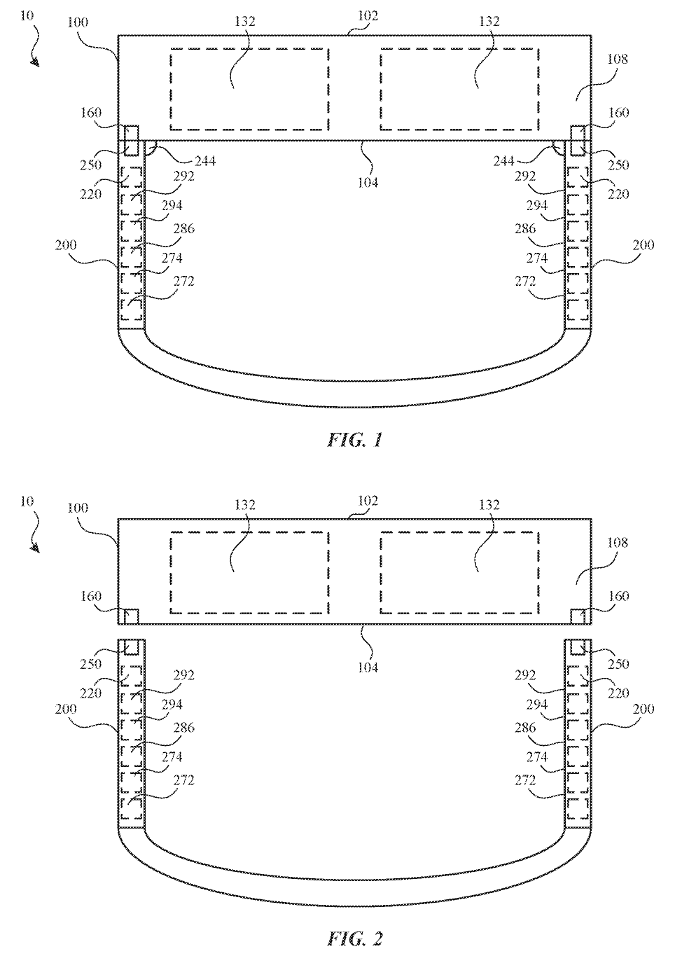

Referring now to FIGS. 1 and 2, a frame and an arm can be arranged in one of a variety of assembly configurations to provide a user with an ability to customize the features thereof and the experience therewith. Such an ability can provide a head-mountable device with exchangeable modules that provide a variety of different components and functions to achieve the results that are desired by a user. For example, a head-mountable device 10 can be provided with an arm 200 that can be detached from the frame 100. Frame engagers 160 of the frame 100 can interact with arm engagers 250 of the arms 200 to provide a secure and reversible coupling. The modular configurations allow a user to easily customize one or more frames with one or more arms to provide features as desired. Multiple frames 100 and/or arms 200 can be easily exchanged with each other to provide different components and functions at different times.

An arm 200 can be connected to a frame 100 in a manner that allows the arm 200 to be removed thereafter. The connection can be fully reversible, such that when the arm 200 and the frame 100 are disconnected, each is restored to a condition held prior to the connection. The connection can be fully repeatable, such that after the arm 200 and the frame 100 are disconnected, the same or a different frame 100 and arm 200 pair can be connected in the same way. The arm 200 and the frame 100 can be securely and temporarily connected, rather than permanently, fixedly, or resiliently connected (e.g., via chemical and/or molecular bond). For example, connection and disconnection of the arm 200 and frame 100 are facilitated in a manner that does not cause permanent damage, harm, or deformation to the arm 200 or the frame 100.

While different arms 200 can provide different features and/or functions, multiple arms 200 can be exchangeable with each other by providing at least some features that are similar or the same among the multiple arms 200. For example, different arms 200 can be secured to a given frame 100 by the same securement mechanism. By further example, different arms 200 can establish a communication link with the given frame 100 via the same communication mechanism. Accordingly, a frame 100 can accommodate the exchange of different arms 200 by providing the same securement mechanism across the different arms 200. Likewise, an arm 200 can accommodate the exchange of different frames 100 by providing the same securement mechanism across the different frames 100.

Additionally or alternatively, at least one of the size, shape, profile, dimension, aspect ratio, surface feature, texture, color, and/or markings can be different among multiple frames 100. For example, different frames 100 can have different sizes and/or shapes to accommodate different head and/or face structures. This can allow a user to choose from among multiple frames 100 that provide different ergonomic features so the user can select one according to comfort provided. By further example, different frames 100 can provide different functional features, such as different lenses for vision correction, so that a user can select a frame 100 that is appropriate for a given activity (e.g., driving, reading, etc.). By further example, different frames 100 can have different aesthetic features to provide the user with different options for fashion and appearance.

As shown in FIGS. 1 and 2, the arm 200 can releasably attach to the frame 100 of the head-mountable device 10 with the frame engagers 160 and the arm engagers 250. For example, the frame engagers 160 and the arm engagers 250 can mechanically engage each other for securement of the arm 200 to the frame 100. The frame engagers 160 and the arm engagers 250 can have complementary shapes to facilitate engagement. For example, the frame engagers 160 and/or the arm engagers 250 can form a protrusion and the arm engagers 250 and/or the frame engagers 160 can form a groove. The groove can have a shape and/or size that complement the shape and/or size of the frame engagers 160. It will be understood that a variety of shapes and/or sizes can be provided to achieve the engagement between the frame engagers 160 and the arm engagers 250. It will be further understood that any number of frame engagers 160 and arm engagers 250 can be provided. While certain mechanical attachment mechanisms are depicted, it will be understood that other mechanical attachment mechanisms are also contemplated.

One or more of a variety of mechanisms can be provided to lock the arm 200 in place with respect to the frame 100. For example, mechanisms such as slides, locks, latches, snaps, screws, clasps, threads, magnets, pins, an interference (e.g., friction) fit, knurl presses, bayoneting, and/or combinations thereof can be included to lock the arm 200 to the frame 100 when the frame engagers 160 and the arm engagers 250 engage each other.

In some embodiments, the frame 100 does not include electronic components. As such, the frame 100 can provide vision correction without excessive weight, size, and power consumption. In such a configuration, the arms 200 can provide computational functions and/or user interaction capabilities. Alternatively, the frame 100 can include one or more of the electronic components described herein with respect to the arms 200.

Additionally or alternatively, a frame 100 can include a display, such as an opaque display configured to display pass-through video, a waveguide, and the like. The features of different frames 100 can provide different types of displays, wherein each can be attached to arms 200 for selection and use by a user, as described further herein.

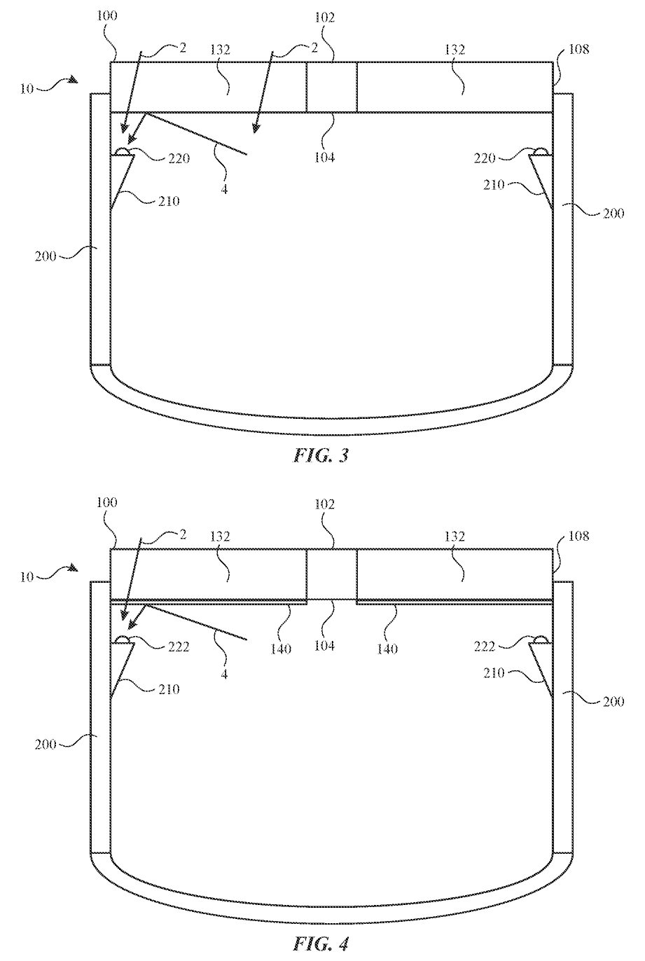

Referring now to FIG. 3, a head-mountable device can include one or more cameras located at one or more arms of the head-mountable device for capturing images based on visible light from an external environment as well as reflected visible light from an eye of a user wearing the head-mountable device. It should be recognized that the head-mountable device 10 of FIG. 3 can include one or more features illustrated and/or described herein with respect to the head-mountable device 10 of any one or more of FIGS. 1-2.

In some embodiments, as shown in FIG. 3, a head-mountable device 10 receives external light 2 from an external environment, such as an environment on the outer side 102 of the frame 100. The external light 2 can include visible light. The external light 2 can include beams of light that are incident upon one or more lenses 132 of the frame 100. In some embodiments, the lens 132 can be configured to transmit at least a portion of the external light 2, such as a portion of the external light 2 that is within the visible spectrum (e.g., light having wavelengths from 380 to 700 nanometers). The external light 2 can be transmitted from the outer side 102 to the inner side 104. As such, the external light 2 can be directed to one or more cameras 220. In some embodiments, the one or more cameras 220 are configured to capture the external light 2 as one or more images. For example, the one or more cameras 220 can be configured to capture light within a particular spectrum (e.g., the visible spectrum). By further example, the one or more cameras 220 can include an RGB camera.

In some embodiments, as further shown in FIG. 3, the external light 2 transmitted through and/or around the one or more lenses 132 of the frame 100 to be incident upon an eye (not shown) of a user wearing the head-mountable device 10. Such light can be reflected by the eye towards the lens 132 as reflected light 4. At least a portion of the reflected light 4 can be reflected by the one or more lenses 132 (e.g., at the inner surface thereof) to arrive at the one or more cameras 220. In some embodiments, the one or more cameras 220 are configured to capture the reflected light 4 along with the external light 2 as one or more images.

In some embodiments, each camera 220 can be positioned on a ledge 210 of a respective arm 200. For example, each ledge 210 can extend inwardly towards the arm 200 on an opposing side of the head-mountable device 10 (e.g., connected to an opposing side of the frame 100). The ledges 210 can direct the respective one or more cameras 220 towards a respective lens 132 to capture the external light 2 and the reflected light 4.

In some embodiments, a single image captured by the one or more cameras 220 can include both the external light 2 from the external environment and the reflected light 4 from the eye. For example, a given region within a field of view of the camera 220 (e.g., representing a portion of lens 132) can include overlaid views of the external environment and the eye. As such, the resulting image captured by camera 220 may be processed to separate the portion of the image that is of the external environment (e.g., from the external light 2) from the portion of the image that is of the eye (e.g., from the reflected light 4). Such image processing can be based on expected images and/or calibration steps that identify one or more visual features of the eye apart from the view of the external environment. As such, such calibration (e.g., via machine learning) can be used as a basis for separating a single captured image into images (and/or other data) corresponding to each of a view of the external environment and a view of the eye.

In some embodiments, the head-mountable device 10 (e.g., by a processor) performs one or more detections based on the separate images (and/or other data) corresponding to each of the view of the external environment and the view of the eye. For example, the head-mountable device 10 can perform a first action (e.g., record the image of the external environment, perform object recognition, etc.) based on a detection of the external environment by the one or more cameras 220 and/or one or more other detected conditions, settings, and/or user inputs. By further example, the head-mountable device 10 can perform a second action (e.g., detect a user input, provide an output, etc.) based on a detection of the eye by the one or more cameras 220 and/or one or more other detected conditions, settings, and/or user inputs. It should be recognized that the actions can be different than each other such that each corresponds to the separate and respective portion of the captured one or more images (e.g., the external environment or the eye).

Accordingly, a single given camera 220 can capture both the external light 2 from the external environment and the reflected light 4 from the eye. By providing an ability to capture both views with a single camera 220, the head-mountable device 10 can provide fewer components, thereby reducing weight, size, and complexity. By providing an ability to capture views based on a particular type of light (e.g., light within the visible spectrum), the light transmitted by the one or more lenses 132 is light that may be of interest for observation by the user. By providing the one or more cameras 220 on the arms 200 rather than the frame 100, the frame 100 can have reduced weight, size, and complexity.

Referring now to FIG. 4, a head-mountable device can include one or more cameras located at one or more arms of the head-mountable device for capturing images based on visible light from an external environment as well as reflected infrared light from an eye of a user wearing the head-mountable device. It should be recognized that the head-mountable device 10 of FIG. 4 can include one or more features illustrated and/or described herein with respect to the head-mountable device 10 of any one or more of FIGS. 1-3.

In some embodiments, as shown in FIG. 4, a head-mountable device 10 receives external light 2 from the external environment, which can include visible light and/or other light (e.g., infrared light, such as light having wavelengths from 750 nm to 1 mm). In some embodiments, the lens 132 can be configured to transmit at least a portion of the external light 2, such as a portion of the external light 2 that is within the visible spectrum. As such, the external light 2 can be directed to one or more cameras 222. In some embodiments, the one or more cameras 222 are configured to capture the external light 2 as one or more images. For example, the one or more cameras 222 can be configured to capture light within a particular spectrum (e.g., the visible spectrum and/or the infrared spectrum). By further example, the one or more cameras 222 can include an RGB-IR camera.

In some embodiments, as further shown in FIG. 4, the eye (not shown) of a user wearing the head-mountable device 10 can emit and/or reflect infrared light as reflected light 4. The reflected light 4 can be emitted by the eye itself (e.g., as heat and/or not as reflected light), reflected from external light 2 from the external environment (e.g., through or around lens 132), and/or reflected from another source. Such light can be emitted and/or reflected by the eye towards the lens 132. At least a portion of the reflected light 4 can be reflected by an inner infrared reflector 140 positioned at an inner surface of the lens 132. The inner infrared reflector 140 can be configured to transmit other types of light, such as visible light, so that the user can directly observe the external environment through the lenses 132 and so that the camera 222 can capture a view of the external environment via the lenses 132. The inner infrared reflector 140 can reflect the reflected light 4 from the eye towards the one or more cameras 222. In some embodiments, the one or more cameras 222 are configured to capture the reflected light 4 along with the external light 2 as one or more images.

In some embodiments, each camera 222 can be positioned on a ledge 210 of a respective arm 200. The ledges 210 can direct the respective one or more cameras 222 towards a respective lens 132 to capture the external light 2 and the reflected light 4.

In some embodiments, a single image captured by the one or more cameras 222 can include both the external light 2 from the external environment and the reflected light 4 from the eye. The external light 2 can include visible light, and the reflected light 4 can include infrared light. The camera 222 can include pixels and/or other mechanisms for distinguishing between light of different wavelengths and/or frequencies. As such, the resulting image captured by camera 222 may be processed to separate the portion of the image that is of the external environment (e.g., from the external light 2) from the portion of the image that is of the eye (e.g., from the reflected light 4) based on the spectrum of light that is attributed to each. As such, the wavelength and/or frequency of different portions of light can be used as a basis for separating a single captured image into images (and/or other data) corresponding to each of a view of the external environment and a view of the eye.

In some embodiments, the head-mountable device 10 (e.g., by a processor) performs one or more detections based on the separate images (and/or other data) corresponding to each of the view of the external environment and the view of the eye. For example, the head-mountable device 10 can perform a first action (e.g., record the image of the external environment, perform object recognition, etc.) based on a detection of light (e.g., within the visible spectrum) corresponding to the external environment by the one or more cameras 222 and/or one or more other detected conditions, settings, and/or user inputs. By further example, the head-mountable device 10 can perform a second action (e.g., detect a user input, provide an output, etc.) based on a detection of light (e.g., within the infrared spectrum) corresponding to the eye by the one or more cameras 222 and/or one or more other detected conditions, settings, and/or user inputs. It should be recognized that the actions can be different than each other such that each corresponds to the separate and respective portion (e.g., spectral component) of the captured one or more images (e.g., the external environment or the eye).

Accordingly, a single given camera 222 can capture both the external light 2 (e.g., visible light) from the external environment and the reflected light 4 (e.g., infrared light) from the eye. By providing an ability to capture both views with a single camera 222, the head-mountable device 10 can provide fewer components, thereby reducing weight, size, and complexity. By providing an ability to capture views based on a particular type of light (e.g., light within either the visible spectrum or the infrared spectrum), the light transmitted by the one or more lenses 132 is light that may be of interest for observation by the user. By providing the one or more cameras 222 on the arms 200 rather than the frame 100, the frame 100 can have reduced weight, size, and complexity.

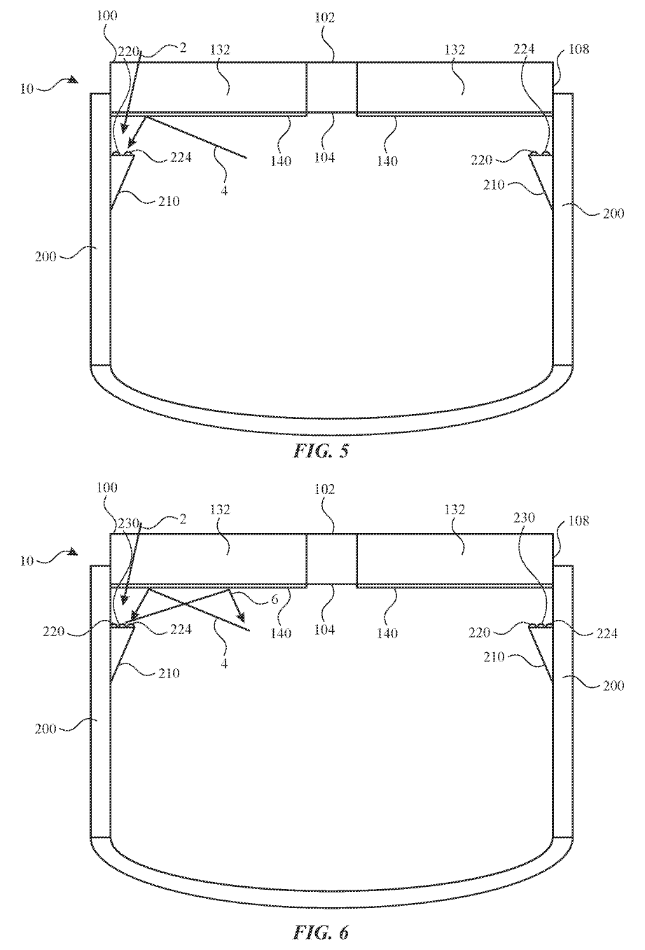

Referring now to FIG. 5, a head-mountable device can include one or more cameras located at one or more arms of the head-mountable device for capturing images based on visible light from an external environment as well as reflected infrared light from an eye of a user wearing the head-mountable device. It should be recognized that the head-mountable device 10 of FIG. 5 can include one or more features illustrated and/or described herein with respect to the head-mountable device 10 of any one or more of FIGS. 1-4.

In some embodiments, as shown in FIG. 5, a head-mountable device 10 receives external light 2 from the external environment, which can include visible light and/or other light (e.g., infrared light). In some embodiments, the lens 132 can be configured to transmit at least a portion of the external light 2, such as a portion of the external light 2 that is within the visible spectrum. As such, the external light 2 can be directed to one or more cameras 220. In some embodiments, the one or more cameras 220 are configured to capture the external light 2 as one or more images. For example, the one or more cameras 220 can be configured to capture light within a particular spectrum (e.g., the visible spectrum). By further example, the one or more cameras 220 can include an RGB camera.

In some embodiments, as further shown in FIG. 5, the eye (not shown) of a user wearing the head-mountable device 10 can emit and/or reflect infrared light as reflected light 4. Such light can be emitted and/or reflected by the eye towards the lens 132. At least a portion of the reflected light 4 can be reflected by an inner infrared reflector 140 positioned at an inner surface of the lens 132. The inner infrared reflector 140 can be configured to transmit other types of light, such as visible light, so that the user can directly observe the external environment through the lenses 132 and so that the camera 220 can capture a view of the external environment via the lenses 132. The inner infrared reflector 140 can reflect the reflected light 4 from the eye towards the one or more cameras 224. In some embodiments, the one or more cameras 224 are configured to capture the reflected light 4 along with the external light 2 as one or more images. For example, the one or more cameras 220 can be configured to capture light within a particular spectrum (e.g., the infrared spectrum). By further example, the one or more cameras 224 can include an infrared camera.

In some embodiments, each camera 220 and/or camera 224 can be positioned on a ledge 210 of a respective arm 200. The ledges 210 can direct the respective one or more cameras 220 and/or cameras 224 towards a respective lens 132 to capture the external light 2 and the reflected light 4.

In some embodiments, the camera 220 captures the external light 2, which can include visible light, and the camera 224 captures the reflected light 4, which can include infrared light. The camera 220 can be configured to omit capture of the reflected light 4, as it may be light (e.g., infrared light) outside of the spectrum specified by the camera 220 (e.g. visible light). Likewise, the camera 224 can be configured to omit capture of the external light 2, as it may be light (e.g. visible light) outside of the spectrum specified by the camera 220 (e.g., infrared light). As such, the resulting images captured by camera 220 and camera 224 may be separate by virtue of their capture by different cameras. As such, the images and/or other data from each camera can be understood to corresponding to the type of light captured thereby.

In some embodiments, the head-mountable device 10 (e.g., by a processor) performs one or more detections based on the separate images (and/or other data) corresponding to each of the view of the external environment and the view of the eye. For example, the head-mountable device 10 can perform a first action (e.g., record the image of the external environment, perform object recognition, etc.) based on a detection of light (e.g., within the visible spectrum) corresponding to the external environment by the one or more cameras 220 and/or one or more other detected conditions, settings, and/or user inputs. By further example, the head-mountable device 10 can perform a second action (e.g., detect a user input, provide an output, etc.) based on a detection of light (e.g., within the infrared spectrum) corresponding to the eye by the one or more cameras 224 and/or one or more other detected conditions, settings, and/or user inputs. It should be recognized that the actions can be different than each other such that each corresponds to the separate and respective portion (e.g., spectral component) of the captured one or more images (e.g., the external environment or the eye).

Accordingly, multiple cameras of different types (e.g., configured to capture different portions of a spectrum) can each capture either the external light 2 (e.g., visible light) from the external environment or the reflected light 4 (e.g., infrared light) from the eye. By providing an ability to capture both views with different types of cameras, the images can be readily recognized as corresponding to either the external environment or the eye. By providing an ability to capture views based on a particular type of light (e.g., light within either the visible spectrum or the infrared spectrum), the light transmitted by the one or more lenses 132 is light that may be of interest for observation by the user. By providing the one or more cameras 220 and one or more cameras 224 on the arms 200 rather than the frame 100, the frame 100 can have reduced weight, size, and complexity.

Referring now to FIG. 6, a head-mountable device can include one or more cameras located at one or more arms of the head-mountable device for capturing images based on visible light from an external environment as well as infrared light projected by an infrared projector and reflected by an eye of a user wearing the head-mountable device. It should be recognized that the head-mountable device 10 of FIG. 6 can include one or more features illustrated and/or described herein with respect to the head-mountable device 10 of any one or more of FIGS. 1-5.

In some embodiments, as shown in FIG. 6, a head-mountable device 10 receives external light 2 from the external environment, which can include visible light and/or other light (e.g., infrared light). In some embodiments, the lens 132 can be configured to transmit at least a portion of the external light 2, such as a portion of the external light 2 that is within the visible spectrum. As such, the external light 2 can be directed to one or more cameras 220. In some embodiments, the one or more cameras 220 are configured to capture the external light 2 as one or more images. For example, the one or more cameras 220 can be configured to capture light within a particular spectrum (e.g., the visible spectrum). By further example, the one or more cameras 220 can include an RGB camera.

In some embodiments, as further shown in FIG. 6, an infrared projector 230 is provided to project (e.g., emit) projected light 6. The projected light 6 can be a type of light that is different from the external light 2. For example, the projected light 6 can be infrared light, whereas the external light can be visible light. The projected light 6 can be directed from the infrared projector 230 toward the lens 132. In some embodiments, the eye (not shown) of a user wearing the head-mountable device 10 can reflect infrared light as reflected light 4. For example, the projected light 6 can be reflected by the eye towards the lens 132. At least a portion of the reflected light 4 can be reflected by an inner infrared reflector 140 positioned at an inner surface of the lens 132. The inner infrared reflector 140 can reflect the reflected light 4 from the eye towards the one or more cameras 224. In some embodiments, the one or more cameras 224 are configured to capture the reflected light 4 along with the external light 2 as one or more images. For example, the one or more cameras 220 can be configured to capture light within a particular spectrum (e.g., the infrared spectrum). By further example, the one or more cameras 224 can include an infrared camera.

In some embodiments, each camera 220, infrared projector 230, and/or camera 224 can be positioned on a ledge 210 of a respective arm 200. The ledges 210 can direct the respective one or more cameras 220, infrared projectors 230, and/or cameras 224 towards a respective lens 132 to project projected light 6 and capture the external light 2 and the reflected light 4.

In some embodiments, the camera 220 captures the external light 2, which can include visible light, and the camera 224 captures the reflected light 4, which can include infrared light. The camera 220 can be configured to omit capture of the reflected light 4, as it may be light (e.g., infrared light) outside of the spectrum specified by the camera 220 (e.g. visible light). Likewise, the camera 224 can be configured to omit capture of the external light 2, as it may be light (e.g. visible light) outside of the spectrum specified by the camera 220 (e.g., infrared light). As such, the resulting images captured by camera 220 and camera 224 may be separate by virtue of their capture by different cameras. As such, the images and/or other data from each camera can be understood to corresponding to the type of light captured thereby.

In some embodiments, the head-mountable device 10 (e.g., by a processor) performs one or more detections based on the separate images (and/or other data) corresponding to each of the view of the external environment and the view of the eye. For example, the head-mountable device 10 can perform a first action (e.g., record the image of the external environment, perform object recognition, etc.) based on a detection of light (e.g., within the visible spectrum) corresponding to the external environment by the one or more cameras 220 and/or one or more other detected conditions, settings, and/or user inputs. By further example, the head-mountable device 10 can perform a second action (e.g., detect a user input, provide an output, etc.) based on a detection of light (e.g., within the infrared spectrum) corresponding to the eye by the one or more cameras 224 and/or one or more other detected conditions, settings, and/or user inputs. It should be recognized that the actions can be different than each other such that each corresponds to the separate and respective portion (e.g., spectral component) of the captured one or more images (e.g., the external environment or the eye).

Accordingly, multiple cameras of different types (e.g., configured to capture different portions of a spectrum) can each capture either the external light 2 (e.g., visible light) from the external environment or the reflected light 4 (e.g., infrared light) from the eye. By providing an ability to project infrared light, the eye can be provided with light sufficient to be reflected for capture by the one or more cameras 224. By providing an ability to capture both views with different types of cameras, the images can be readily recognized as corresponding to either the external environment or the eye. By providing an ability to capture views based on a particular type of light (e.g., light within either the visible spectrum or the infrared spectrum), the light transmitted by the one or more lenses 132 is light that may be of interest for observation by the user. By providing the one or more cameras 220 and one or more cameras 224 on the arms 200 rather than the frame 100, the frame 100 can have reduced weight, size, and complexity.

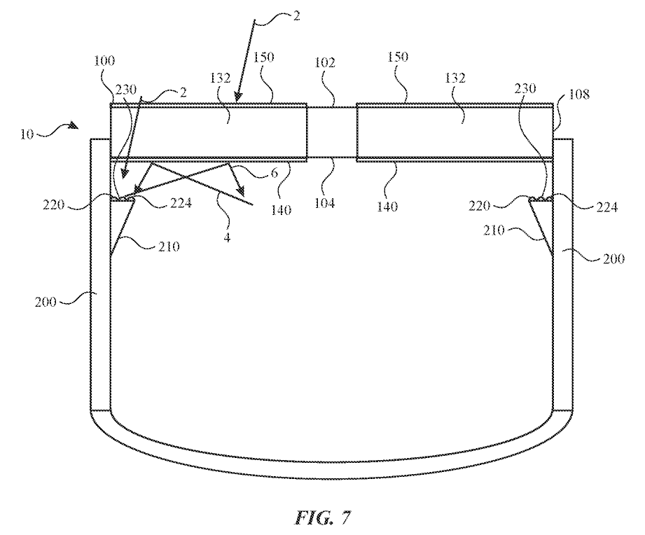

Referring now to FIG. 7, a head-mountable device can include one or more cameras located at one or more arms of the head-mountable device for capturing images based on visible light from an external environment as well as infrared light projected by an infrared projector and reflected by an eye of a user wearing the head-mountable device. It should be recognized that the head-mountable device 10 of FIG. 7 can include one or more features illustrated and/or described herein with respect to the head-mountable device 10 of any one or more of FIGS. 1-6.

In some embodiments, as shown in FIG. 7, a head-mountable device 10 can include one or more features as illustrated and described with respect to the head-mountable device 10 of FIG. 6. Further to the above description, at least a portion of the external light 2 can be reflected by an outer infrared reflector 150 positioned at an outer surface of the lens 132. The outer infrared reflector 150 can reflect a portion of the external light 2 from the external environment away from the eye (not shown) of the user. The external light 2 that is transmitted by the outer infrared reflector 150, the lens 132, and/or the inner infrared reflector can be another type of light, such as visible light.

Accordingly, by providing an ability to reflect infrared light, the eye, the lens 132, and/or other components of the head-mountable device 10 can be protected from infrared light. In the case of the eye, this can allow projected light 6 to be a greater portion of the infrared light that is incident on the eye, thereby allowing the indications provided by the reflected light 4 to be clearer than would be provided in the presence of additional infrared light. In the case of the lens 132 and/or other components of the head-mountable device 10, this can such components to maintain a cooler temperature and reduce reflection and/or emission of additional infrared light, thereby allowing the indications provided by the reflected light 4 to be clearer than would be provided in the presence of additional infrared light.

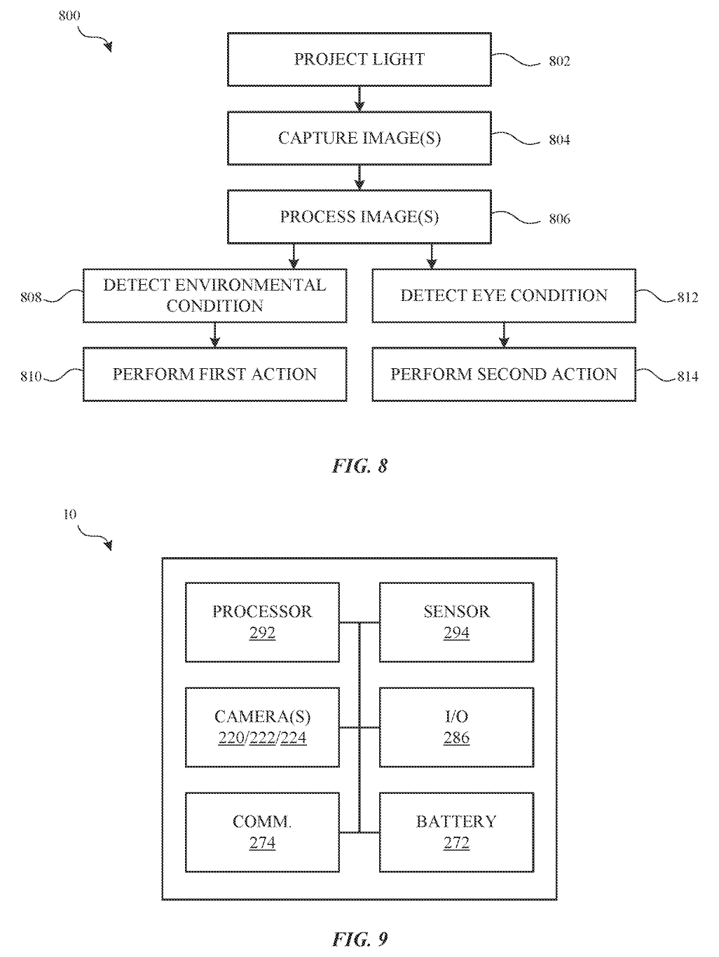

FIG. 8 illustrates a flow diagram of an example process 800 for determining a recommended assembly. For explanatory purposes, the process 800 is primarily described herein with reference to the head-mountable device 10. However, the process 800 is not limited to the head-mountable device 10, and one or more blocks (or operations) of the process 800 may be performed by different components of the head-mountable device and/or one or more other devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In operation 802, the process 800 can be initiated. In some embodiments, a light projector (e.g., an infrared projector) projects light that is directed to (e.g., reflected to) an eye of a user. In some embodiments, light need not be projected, for example where external light from an external environment is sufficient to provide light that can be reflected by the eye.

In operation 804, one or more images are captured by one or more cameras of the head-mountable device. In some embodiments, one or more images are captured by a single camera. In some embodiments, one or more images are captured by multiple cameras. For example, different cameras can capture light of different types (e.g., wavelengths and or frequencies). In some embodiments, the captured images correspond to a field of view that includes a lens through which external light is transmitted and/or reflected light (e.g., from an eye) is reflected.

In operation 806, the one or more images can be processed (e.g., by a processor) for performing one or more detections based thereon. In some embodiments, where a single image is captured by a camera (e.g., camera 220), the captured image can include both the external light (e.g., visible light) from the external environment and the reflected light (e.g., visible light) from the eye. As such, the resulting image captured by the camera may be processed to separate the portion of the image that is of the external environment (e.g., from the external light) from the portion of the image that is of the eye (e.g., from the reflected light). In some embodiments, where a single image is captured by a camera (e.g., camera 222), the captured image can include both the external light (e.g., visible light) from the external environment and the reflected light (e.g., infrared light) from the eye. As such, the resulting image captured by the camera may be processed to separate the portion of the image that is of the external environment (e.g., from the external light 2) from the portion of the image that is of the eye (e.g., from the reflected light 4) based on the spectrum of light that is attributed to each (e.g., as distinguished by separate pixels of the camera). In some embodiments, where different cameras (e.g., of different types) captures separate images, the resulting images may be separate by virtue of their capture by different cameras. As such, the images and/or other data from each camera can be understood to corresponding to the type of light captured thereby.

In operation 808, the head-mountable device (e.g., by a processor) performs one or more detections based on the images (and/or other data) corresponding to the view of the external environment. The detections can include one or more conditions in the external environment. Such a detection can include recognition of a visual feature in the external environment. The detection can correspond to a condition for which the head-mountable device is configured to perform an action in response to the detection of the condition and/or one or more other determinations.

In operation 810, in response to detection of the environmental condition, the head-mountable device (e.g., by a processor) performs a first action. In some embodiments, the first action is performed if and only if the detected environmental condition satisfies one or more criteria and/or if one or more other criteria are satisfied. For example, the first action can be performed is the detected condition has a characteristic that satisfies a threshold, range, value, and the like. If the detected condition does not satisfy the one or more criteria and/or if one or more other criteria are not satisfied, the head-mountable device can forgo performing the first action. The first action can include any action, such as recording the image of the external environment, performing object recognition, providing an output, communicating with another device, and the like.

In operation 812, the head-mountable device (e.g., by a processor) performs one or more detections based on the images (and/or other data) corresponding to the view of the eye. The detections can include one or more conditions of the eye (e.g., eye gaze direction, pupil location, pupil size, focal distance, eyelid status, blinking, moisture conditions, and the like). Such a detection can include recognition of a visual feature of the eye. The detection can correspond to a condition for which the head-mountable device is configured to perform an action in response to the detection of the condition and/or one or more other determinations.

In operation 814, in response to detection of the eye condition, the head-mountable device (e.g., by a processor) performs a second action. In some embodiments, the second action is performed if and only if the detected environmental condition satisfies one or more criteria and/or if one or more other criteria are satisfied. For example, the second action can be performed is the detected condition has a characteristic that satisfies a threshold, range, value, and the like. If the detected condition does not satisfy the one or more criteria and/or if one or more other criteria are not satisfied, the head-mountable device can forgo performing the second action. The second action can include any action, such as detecting a user input (e.g., detecting the eye condition as a user input), providing an output, communicating with another device, and the like. The second action can be different than the first action, such that the head-mountable device responds to detection of the environmental condition in a manner that is different than the manner in which it responds to detection of the eye condition.

In some embodiments, the head-mountable device (e.g., by a processor) performs an action based on both the detection of the environmental condition and the detection of the eye condition. For example, the head-mountable device perform an action in response to detection of an environmental condition and detection of an eye condition in accordance with a determination that the environmental condition satisfies one or more criteria and a determination that the eye condition satisfies one or more criteria. In some embodiments, in accordance with a determination that the environmental condition satisfies one or more criteria or a determination that the eye condition satisfies one or more criteria, the head-mountable device can forgo performing the action. As such, a unified camera system making multiple detections can provide a head-mountable device to determine whether to perform an action based on the detections thereof.

Referring now to FIG. 9, components of the head-mountable device can be provided and operatively connected to achieve the performance described herein. FIG. 9 shows a simplified block diagram of a head-mountable device 10 in accordance with one or more embodiments of the disclosure. It will be appreciated that components described herein, as well as other components, can be provided on either or both of multiple arms and/or a frame of the head-mountable device 10. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The head-mountable device 10 can include a processor 292, which may also be referred to as an application processor or a processor, may include suitable logic, circuitry, and/or code that enable processing data and/or controlling operations of the head-mountable device 10. In this regard, the processor 292 may be enabled to provide control signals to various other components of the head-mountable device 10. The processor 292 may also control transfers of data between various portions of the head-mountable device 10. Additionally, the processor 292 may enable implementation of an operating system or otherwise execute code to manage operations of the head-mountable device 10. The processor 292 may access memory, which may include suitable logic, circuitry, and/or code that enable storage of various types of information such as received data, generated data, code, and/or configuration information. The memory may include, for example, random access memory (RAM), read-only memory (ROM), flash, and/or magnetic storage.

The head-mountable device 10 can include one or more sensors 294. Such sensors 294 can be configured to sense substantially any type of characteristic such as, but not limited to, images, pressure, light, touch, force, temperature, position, motion, and so on. For example, the sensor 294 may be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. The sensor 294 can be used to sense ambient conditions in a neighboring environment. In some embodiments, the sensor 294 may be a bio-sensor. The one or more bio-sensors can include optical and/or electronic biometric sensors that may be used to compute one or more biometric characteristics. For example, a bio-sensor can include a light source and a photodetector to form a photoplethysmography (PPG) sensor. An optical (e.g., PPG) sensor or sensors may be used to compute various biometric characteristic including, without limitation, a heart rate, a respiration rate, blood oxygenation level, a blood volume estimate, blood pressure, or a combination thereof. One or more of the bio-sensors may also be configured to perform an electrical measurement using one or more electrodes. The electrical sensor(s) may be used to measure electrocardiographic (ECG) characteristics, galvanic skin resistance, and other electrical properties of the user’s body. Additionally or alternatively, a bio-sensor can be configured to measure body temperature, exposure to UV radiation, and other health-related information. In some embodiments, the sensor 294 may be a user sensor. Such sensors can be used to detect features relating to the user wearing the head-mountable device and/or other individuals. For example, user sensors can perform facial feature detection, facial movement detection, facial recognition, eye tracking, user mood detection, user emotion detection, voice detection, etc.

The head-mountable device 10 can include one or more cameras 220, 222, and/or 224. For example, the head-mountable device 10 can include a camera for capturing a view of an environment external to the head-mountable device 10 and/or an eye of the user. The one or more cameras 220, 222, and/or 224 can include an optical sensor, such as a photodiode or a photodiode array, a charge-coupled device (CCD) and/or a complementary metal-oxide-semiconductor (CMOS) device, a photovoltaic cell, a photo resistive component, a laser scanner, and the like.

The head-mountable device 10 can include an input/output component 286, such as a user interface, for allowing a user to provide input and/or receive output. The input/output component 286 can include, for example, one or more buttons, touchscreens, keyboards, microphones, cameras, and the like. The input/output component 86 can further include, for example, one or more speakers, haptic devices, displays, and the like. In some embodiments, the input/output component 286 is operable with the head-mountable device 10. For example, a speaker (e.g., earpiece) can be provided by or connectable to a frame and/or an arm. Such a speaker component can be a modular component that can operate independently of and/or in concert with the head-mountable device 10. The speaker component can wirelessly communication with the head-mountable device 10 and/or another device. A haptic device can be implemented as any suitable device configured to provide force feedback, vibratory feedback, tactile sensations, and the like. For example, in one embodiment, the haptic device may be implemented as a linear actuator configured to provide a punctuated haptic feedback, such as a tap or a knock.

The head-mountable device 10 can include a communication interface 274, which can include suitable logic, circuitry, and/or code that enables wired or wireless communication. The communication interface 274 of any given device can providing a communication link with the communication element of any other device. Such communication can be direct or indirect (e.g., through an intermediary). The communication interface 274 may include, for example, one or more of a Bluetooth communication element, an NFC interface, a Zigbee communication element, a WLAN communication element, a USB communication element, or generally any communication element.

The head-mountable device 10 can include a battery 272, which can charge and/or power components of the head-mountable device 10. The battery 272 can also charge and/or power components connected to the head-mountable device 10. The battery 272 can be a replaceable battery, a rechargeable battery, or a tethered power source that receives power from a source external to the arm head-mountable device 10, such as from a USB cable, Lightening cable, or other interface. One or more batteries 272 of the head-mountable device 10 can transfer power to and/or receive power from another device. Such power transfer can be wired and/or wireless.

The head-mountable device 10 can further include any number of additional electronic components, for example at one or more arms. By providing electronic components on a removable arm, the user can select an arm providing selected functions when desired. At other times, other arms can be selected, thereby reducing the need to have all features available at all times in the frame or in a fixed arm.

It will be understood that the components of either the frame or arms discussed herein can be provided on either or both of the frame and/or the arm. Furthermore, selection of different modules (e.g., frames and/or arms) provides a customized experience for a user.

Accordingly, embodiments of the present disclosure provide a head-mountable device with components that provide eye tracking and image capture of an external environment from a location at one or more arms of the head-mountable device. The frame can provide one or more lenses that facilitate optical detections by cameras at the one or more arms. Accordingly, a frame of the present disclosure need not include components to manage eye tracking and image capture of the external environment. From a set of one or more images, the head-mountable device can determine whether to perform one or more actions based on detected environmental conditions and/or detected eye conditions.

Various examples of aspects of the disclosure are described below as clauses for convenience. These are provided as examples, and do not limit the subject technology.

Clause A: a head-mountable device comprising: a frame comprising: a lens configured to transmit visible light; and an inner infrared reflector on an inner surface of the lens and configured to transmit the visible light and reflect infrared light from an eye; and multiple arms extending from opposing sides of the frame, at least one of the arms comprising a camera configured to capture the visible light transmitted through the lens and the infrared light reflected by the inner infrared reflector.

Clause B: a head-mountable device comprising: a frame comprising a lens; an arm extending from the frame and comprising one or more cameras configured to capture an image from a first light transmitted through the lens and a second light from an eye and reflected by an inner surface of the lens; and a processor configured to: process the image to detect an environmental condition based on the first light and an eye condition based on the second light; perform a first action based on the environmental condition; and perform a second action based on the eye condition, the second action being different than the first action.

Clause C: a head-mountable device comprising: an arm comprising: an infrared projector configured to project infrared light; and an infrared camera; a frame connected to the arm, the frame comprising: a lens; an outer infrared reflector on an outer surface of the lens and configured to reflect first infrared light from an outer side of the head-mountable device; and an inner infrared reflector on an inner surface of the lens and configured to reflect infrared light from the infrared projector onto an eye and reflect second light from the eye to the infrared camera.

One or more of the above clauses can include one or more of the features described below. It is noted that any of the following clauses may be combined in any combination with each other, and placed into a respective independent clause, e.g., clause A, B, or C.

Clause 1: the at least one of the arms further comprises an infrared projector configured to project the infrared light.

Clause 2: the frame further comprises an outer infrared reflector on an outer surface of the lens and configured to reflect additional infrared light from an outer side of the head-mountable device.

Clause 3: the multiple arms comprise ledges protruding towards each other, the camera being positioned on one of the ledges and facing the lens.

Clause 4: the camera is a first camera, wherein the arms include a first arm extending from a first side of the frame and a second arm extending from a second side of the frame, wherein the first arm includes the at least one of the arms, and wherein the second arm comprises a second camera.

Clause 5: the frame further comprises frame engagers; and each of the multiple arms further comprises a respective arm engager configured to releasably couple a respective one of the multiple arms to a respective one of the frame engagers.

Clause 6: the first light is visible light, and wherein the second light is infrared light.

Clause 7: the frame further comprises: an inner infrared reflector on the inner surface of the lens and configured to reflect the second light from the eye to the one or more cameras.

Clause 8: the first action includes recording the image in a memory, and wherein the second action includes, in response to an input indicated by the eye condition, providing an output with an output device of the head-mountable device.

Clause 9: the one or more cameras consists of a single camera.

Clause 10: the arm further comprises an additional camera configured to capture visible light.

Clause 11: the arm further comprises: a processor for operating the infrared projector and the infrared camera; a communication interface for communicating with another device; and a battery.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person’s physical motions, or representations thereof, are tracked, and, in response, one or more characteristics of one or more virtual objects simulated in the CGR environment are adjusted in a manner that comports with at least one law of physics. For example, a CGR system may detect a person’s head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person’s presence within the computer-generated environment, and/or through a simulation of a subset of the person’s physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame comprising:
a lens configured to transmit visible light; and
an inner infrared reflector on an inner surface of the lens and configured to transmit the visible light and reflect infrared light from an eye; and
multiple arms extending from opposing sides of the frame, at least one of the arms comprising a camera configured to capture the visible light transmitted through the lens and the infrared light reflected by the inner infrared reflector.

2. The head-mountable device of claim 1, wherein the at least one of the arms further comprises an infrared projector configured to project the infrared light.

3. The head-mountable device of claim 1, wherein the frame further comprises an outer infrared reflector on an outer surface of the lens and configured to reflect additional infrared light from an outer side of the head-mountable device.

4. The head-mountable device of claim 1, wherein the multiple arms comprise ledges protruding towards each other, the camera being positioned on one of the ledges and facing the lens.

5. The head-mountable device of claim 1, wherein the camera is a first camera, wherein the arms include a first arm extending from a first side of the frame and a second arm extending from a second side of the frame, wherein the first arm includes the at least one of the arms, and wherein the second arm comprises a second camera.

6. The head-mountable device of claim 1, wherein:
the frame further comprises frame engagers; and
each of the multiple arms further comprises a respective arm engager configured to releasably couple a respective one of the multiple arms to a respective one of the frame engagers.

7. A head-mountable device comprising:
a frame comprising a lens;
an arm extending from the frame and comprising one or more cameras configured to capture an image from a first light transmitted through the lens and a second light from an eye and reflected by an inner surface of the lens; and
a processor configured to:
process the image to detect an environmental condition based on the first light and an eye condition based on the second light;
perform a first action based on the environmental condition; and
perform a second action based on the eye condition, the second action being different than the first action.

8. The head-mountable device of claim 7, wherein the first light is visible light, and wherein the second light is infrared light.

9. The head-mountable device of claim 7, wherein the frame further comprises:
an inner infrared reflector on the inner surface of the lens and configured to reflect the second light from the eye to the one or more cameras; and
an outer infrared reflector on an outer surface of the lens and configured to reflect infrared light from an outer side of the head-mountable device.

10. The head-mountable device of claim 7, wherein the first action includes recording the image in a memory, and wherein the second action includes, in response to an input indicated by the eye condition, providing an output with an output device of the head-mountable device.

11. The head-mountable device of claim 10, wherein the arm is a first arm extending from a first side of the frame and wherein the one or more cameras is a first set of one or more cameras, the head-mountable device further comprising a second arm extending from a second side of the frame, the second arm comprising a second set of one or more cameras.

12. The head-mountable device of claim 11, wherein the lens is a first lens, wherein the first arm comprises a first ledge extending towards the second arm and directing the first set of one or more cameras towards the first lens, and wherein the second arm comprises a second ledge extending towards the first arm and directing the second set of one or more cameras towards a second lens of the frame.

13. The head-mountable device of claim 7, wherein the one or more cameras consists of a single camera.

14. The head-mountable device of claim 7, wherein:
the frame further comprises frame engagers; and
the arm further comprises an arm engager configured to releasably couple the arm to a respective one of the frame engagers.

15. A head-mountable device comprising:
an arm comprising:
an infrared projector configured to project infrared light; and
an infrared camera;
a frame connected to the arm, the frame comprising:
a lens;
an outer infrared reflector on an outer surface of the lens and configured to reflect first infrared light from an outer side of the head-mountable device; and
an inner infrared reflector on an inner surface of the lens and configured to reflect infrared light from the infrared projector onto an eye and reflect second light from the eye to the infrared camera.

16. The head-mountable device of claim 15, wherein the arm further comprises an additional camera configured to capture visible light.

17. The head-mountable device of claim 15, wherein the arm is a first arm extending from a first side of the frame, the infrared projector is a first infrared projector, and the infrared camera is a first infrared camera, the head-mountable device further comprising a second arm extending from a second side of the frame, the second arm comprising a second infrared projector and a second infrared camera.

18. The head-mountable device of claim 17, wherein the lens is a first lens, wherein the first arm comprises a first ledge extending towards the second arm and directing the first infrared projector and the first infrared camera towards the first lens, and wherein the second arm comprises a second ledge extending towards the first arm and directing the second infrared projector and the second infrared camera towards a second lens of the frame.

19. The head-mountable device of claim 15, wherein:
the frame further comprises frame engagers; and
the arm further comprises an arm engager configured to releasably couple the arm to a respective one of the frame engagers.

20. The head-mountable device of claim 15, wherein the arm further comprises:
a processor for operating the infrared projector and the infrared camera;
a communication interface for communicating with another device; and
a battery.
